(19) United States
(12) Patent Application Publication
(10) Pub. No.: US 2016/0194470 A1
(43) Pub. Date: Jul. 7, 2016

(54) SHAPED PARTS MADE OF REINFORCED POLYURETHANE UREA ELASTOMERS AND USE THEREOF

(71) Applicant: COVESTRO DEUTSCHLAND AG, Leverkusen (DE)

(72) Inventors: Florian HUPKA, Düsseldorf (DE); Michael BÄCKER, Korschenbroich (DE); Birgit MEYER ZU BERSTENHORST, Leverkusen (DE)

(21) Appl. No.: 14/906,607

(22) PCT Filed: Jul. 18, 2014
(86) PCT No.: PCT/EP2014/065529

§ 371 Date: Jan. 21, 2016

(30) Foreign Application Priority Data
Jul. 23, 2013 (EP) 13177522.3

(51) Int. Cl. C08J 9/00; C08K 7/06; C08G 18/72; C08J 9/08; C08G 18/08; C08G 18/66

(52) U.S. Cl. CPC C08J 9/0085; C08G 18/14; C08G 18/6685; C08G 18/72; C08G 18/0838; C08J 9/08; C08K 7/06; C08J 2203/02; C08J 2375/12; C08G 2101/0066

(57) ABSTRACT

The invention relates to foamed shaped parts provided with reinforcing materials and made from polyurethane urea elastomers, and to the use thereof.

The invention relates to foamed moldings made of polyurethane urea elastomers and provided with reinforcing materials, and to the use of said moldings.

The production of polyurethane (PUR) urea elastomers via reaction of NCO semiprepolymers with mixtures of aromatic diamines and relatively high-molecular-weight compounds containing hydroxy or amino groups is known, and is described by way of example in EP-B 225 640. In order to achieve certain mechanical properties in the moldings produced from these materials it is necessary to add reinforcing materials to the reaction components, particular results here being improvement of the thermomechanical properties and a considerable increase in flexural modulus of elasticity. The use of these reinforcing materials markedly increases the viscosity of at least one reaction component (generally the polyol component), and this often leads to mixing problems and thus to processing problems which ultimately affect the component.

It is desirable to find reinforced polyurethane urea elastomers which, during the production of sheet-like moldings, for example wheel surrounds, doors, or tailgates of automobiles, can easily be separated from the molds with minimal addition of release aids, thus ensuring maximal cycle times via a system providing easy release.

EP-A 1004 606 obtains good release properties of reinforced PUR urea elastomers by raising the functionality of the polyol reaction component to from 4 to 8 and the functionality of the polyol component used during the production of the isocyanate prepolymer component to from 3 to 8.

A factor of constantly increasing importance specifically in the automobile industry is weight saving. In the case of polyurethane urea elastomers it is possible to control, within a certain range, the density and thus the weight of a molding via the quantity of the reaction mixture introduced into the mold. However, the moldings are generally microcellular elastomers, i.e. are not genuine foams with a foam structure visible to the naked eye. This means that any organic blowing agents concomitantly used function more as flow aid rather than as genuine blowing agent, e.g. as described in WO 2012/126934 A1 WO 2012/126934 A1 moreover says that a noticeable density reduction can be achieved in principle via increased content of blowing agent and introduction of a smaller quantity into the mold. In practice, however, this does not represent a practicable possibility for significant weight reduction because even a small increase in the degree of foaming of the microcellular elastomers reduces in particular the flexural modulus of elasticity to an unacceptable level.

The density of the resultant moldings is also, of course, greatly dependent on the nature and the proportion by weight of the fillers concomitantly used. EP-A 639614 says that it is possible to achieve a density reduction by using hollow microbeads made of glass or ceramic. Relevant factors here are not only the comparatively low density of the hollow microbeads per se but also the ability of the microbeads to permit higher gas-loading of the polyol formulation (A-component), resulting in a higher degree of foaming. Although mineral fibers are also used as reinforcing materials in addition to the hollow microbeads, the disadvantage of said process is that it is only possible to produce moldings having relatively low flexural moduli of elasticity. Numerous examples are provided, the highest flexural modulus of elasticity achieved being 486 MPa. However, values of at least 600 MPa, and in certain applications indeed at least 1000 MPa, are essential for bodywork components in the automobile industry.

EP-B 0267603 describes how the use of relatively small quantities of carbon fibers as reinforcing material can give polyurethane urea elastomers having properties comparable with those of elastomers reinforced with markedly higher quantities of glass fibers. The average fiber length of the carbon fibers used there is from 0.3 to 0.4 mm. However, it has been found in practice that fibrous fillers with fiber lengths greater than 0.2 mm are extremely difficult to process. Specifically, the nozzles used in the RIM (reaction injection molding) process tend to block under those conditions, causing extreme pressure variations at the high-pressure mixing heads and thus varying quality of mixing of A-component (polyol component) and B-component (isocyanate component). During continuous production this leads to inadequate process reliability, but process reliability is essential specifically for conveyor-belt production in the automobile industry.

WO 2012/126934 A1 describes how it is possible to provide moldings which not only have good thermomechanical properties but also have significantly lower density than familiar polyurethane urea elastomers, moreover having a flexural modulus of elasticity of at least 600 Mpa, good release properties, and short residence times. This is achieved by using a combination of specific hollow microbeads and carbon fibers with maximal average fiber length 0.2 mmm, in order to ensure process reliability. This process has the disadvantage that not only carbon fibers but also the hollow microbeads are preferably incorporated into the A-component, and the viscosity of said A-component therefore rises markedly. Temperatures of the A-component during processing therefore have to be increased, and this is uneconomic. Increased solids content in the two components A and B moreover contribute to a certain lack of process reliability, because the nozzles of the RIM system can block during the processing of solids, and this is in turn attended by pressure variations at the high-pressure mixing heads and differences in distributions of the hollow microbeads and carbon fibers in the molding. The hollow microbeads used are moreover very expensive, and act as a type of defined fracture point in the molding, this being reflected in the poor impact resistance values.

It was therefore an object of the present invention to provide polyurethane urea elastomers and moldings produced therewith which have good thermomechanical properties, significantly lower density than familiar polyurethane urea elastomers, flexural modulus of elasticity of at least 600 MPa, good release properties, and short residence times. In order to ensure process reliability, no fibrous reinforcing materials with average fiber length greater than 0.2 mm are to be used.

Surprisingly, said object has been achieved by providing carbon fibers of a certain length to a polyurethane urea elastomer of a certain composition, with use of certain ammonium carbamates as blowing agents.

The present invention therefore provides foamed moldings made of polyurethane urea elastomers and provided with reinforcing materials and having from 70 to 95 mol % urea content and from 5 to 30 mol % urethane content, based in each case on mol % of an NCO equivalent, obtainable via reaction of a reaction mixture composed of an

A-component composed of
A1) aromatic diamines which at least in a respective ortho-position with respect to the amino groups have an alkyl substituent,

A2) at least one aliphatic component composed of at least one polyether polyol and/or polyester polyol in each case having hydroxy and/or primary amino groups with number-average molecular weight from 500 to 18,000 and functionality from 3 to 8, and
A3) optionally catalysts and/or optionally additives,
   and of, as B-component, a prepolymer containing isocyanate groups and obtainable via reaction of a reaction mixture composed of
B1) a polyisocyanate component from the group consisting of polyisocyanates and polyisocyanate mixtures of the diphenylmethane group and of liquefied polyisocyanates of the diphenylmethane group, and
B2) at least one polyol component with number-average molecular weight from 500 to 18,000 and functionality from 2.7 to 8 from the group consisting of polyether polyols which optionally comprise organic fillers and polyester polyols which optionally comprise organic fillers,
   characterized in that
   ammonium carbamate salts (A4) are comprised in component A and carbon fibers (C) with average fiber length from 60 to 200 μm are comprised in component A or component B or both components.

The ammonium carbamate salts used as blowing agents and comprising at least 2 OH groups correspond to the formula I):

HO—X—N(R¹)H₂⁺ —O—C(O)—N(R¹)—X—OH R¹=H, C₁-C₅-alkyl moiety or —X—OH X=[CR²R³]ₙ n=2-6=(CR²R³)ₚ-[—O—(—CR²R³—)-ₚ]_{q} p=2-4 q=1-10=(CR²R³)-[—N(R⁴)-(—CR²R³—)-ᵣ]ₛ r=2-4 s=1-10R², R³=H, C₁-C₅-alkyl moiety R4=H, C₁-C₅-alkyl moiety or —X—OH (I)

The production of the ammonium carbamate salts is described in EP 0652250 B1.

The use of the ammonium carbamate salts (A4) as blowing agents significantly reduces the density of the polyurethane urea elastomers without excessive foaming. The carbon fibers (C) achieve the required thermomechanical properties and in particular the necessary flexural modulus of elasticity. If glass fiber or mineral fiber based on silicate were to be used as in EP 639614 A1 instead of the carbon fiber, this would have led to significantly higher density of the molding, because of the markedly higher necessary mass of fiber. Use of hollow microbeads, as described in WO 2012/126934 leads not only to poor impact resistance of the molding, in particular at low temperatures, but also to difficulties with tensile strain at break and with processing, because of high filler content (carbon fiber and hollow microbeads), and leads to a significant price increase due to the hollow microbeads. The price reduction due to reduction of the mass of polyurethane matrix is thus negated by the high price of the hollow glass beads, or indeed the price of the molding is increased.

The quantitative proportion of the A-component and B-component reacted is such that the isocyanate index of the resultant elastomer is preferably in the range from 80 to 120, and that the polyol component 82) introduced by way of the B-component preferably produces from 10 to 90 mol % of the urethane content in the elastomer.

It is preferable to use reinforced polyurethane elastomers with from 75 to 90 mol % urea content and from 10 to 25 mol % urethane content, based on mol % of an NCO equivalent.

The quantitative proportion of the A-component and B-component reacted is particularly preferably such that the isocyanate index of the resultant elastomer is preferably in the range from 90 to 115, and that the polyol component B2) introduced by way of the B-component preferably produces from 30 to 85 mol % of the urethane content in the elastomer.

Examples of carbon fibers (C) (C fibers) that can be used are the ground carbon fiber grades Sigratil® C10 M250 UNS and Sigratil® C30 M150 UNS from SGL Carbon or Tenax®-A HT M100 100 mu and Tenax®-A HT M100 60 mu from Toho Tenax Europe GmbH or CFMP-150 90 μm from NIPPON POLYMER SANGYO CO., LTD., obtainable from Dreychem. Preference is given to carbon fibers with average fiber length from 60 to 200 μm, particularly from 90 to 200 μm, particularly from 90 to 170 μm.

The quantities usually added of the carbon fibers in the process of the invention are from 1 to 20% by weight, preferably from 1 to 15% by weight, particularly preferably from 1 to 10% by weight, and with particular preference from 3 to 7% by weight, based on the total quantity of components A, B, C, and D.

As described above, an “A-component” is reacted with a “B-component”, and it is preferable here that the A-component comprises the ammonium carbamate salts (A4) and the carbon fibers (C).

In the invention ammonium carbamate salts are used as component (A4) and generate the actual blowing effect, and promote good processing of the two components A) and B) via improved flow of the liquid component A).

The ammonium carbamate salts used in the invention are compounds of the abovementioned general formulae. The ammonium carbamate salts are produced via simple saturation of the underlying alkanolamines with gaseous or solid carbon dioxide at temperatures of from 40 to 130° C. Particularly preferred alkanolamines for the production of the ammonium carbamates are ethanolamine, isopropanolamine, 3-amino-1-propanol, N-methylethanolamine, 2-(2-aminoethoxy)ethanol, N-(2-aminoethyl)ethanolamine, and mixtures of alkanolamines of this type.

The ammonium carbamates are added exclusively to the A-component. The quantity of the ammonium carbamates added and the quantity of the reaction mixture introduced into the mold are such that the density of the moldings is from 0.7 to 1.1 g/cm³, preferably from 0.8 to 1.1 g/cm³, particularly preferably from 0.9 to 1.1 g/cm³, and with particular preference from 0.9 to 1.0 g/cm³.

Compounds that can be used as component A1) are aromatic diamines which at least in a respective ortho-position with respect to the amino groups have an alkyl substituent and which have a molecular weight of from 122 to 400. Particular preference is given to those aromatic diamines which have, in ortho-position with respect to the first amino group, at least one alkyl substituent and, in ortho-position with respect to the second amino group, two alkyl substituents, having respectively from 1 to 4, preferably from 1 to 3, carbon atoms. Very particular preference is given to those which in respectively at least one ortho-position with respect to the amino groups have an ethyl, n-propyl, and/or isopropyl substituent and optionally have methyl substituents in other ortho-positions with respect to the amino groups. Examples of diamines of this type are 2,4-diaminomesitylene, 1,3,5-triethyl-2,4-diaminobenzene, and its technical mixtures with 1-methyl-3,5-diethyl-2,6-diaminobenzene, and 3,5,3′,5′-tetraisopropyl-4,4′-diaminodiphenylmethane. The mixtures of these compounds with one another can, of course, likewise be used. It is particularly preferable that component A1) is 1-methyl-3,5-diethyl-2,4-diaminobenzene or its technical mixtures with 1-methyl-3,5-diethyl-2,6-diaminobenzene (DETDA).

Component A2) is composed of at least one aliphatic polyether polyol and/or polyester polyol which in each case has hydroxy and/or primary amino groups and molecular weight from 500 to 18,000, preferably from 1000 to 16,000, with preference from 1500 to 15,000.

Component A2) has the abovementioned functionalities. The polyether polyols can be produced in a manner known per se via alkoxylation of starter molecules or mixtures of these of appropriate functionality, and the alkoxylation reaction here in particular uses propylene oxide and ethylene oxide. Suitable starters or starter mixtures are sucrose, sorbitol, pentaerythritol, glycerol, trimethylolpropane, propylene glycol, and water. Preference is given to those polyether polyols having hydroxy groups composed of at least 50%, preferably at least 70%, in particularly 100%, of primary hydroxy groups.

Compounds that can be used as polyester polyols are in particular those composed of the dicarboxylic acids known for this purpose, for example adipic acid, phthalic acid, and of polyhydric alcohols, for example ethylene glycol, 1,4-butanediol, and optionally a proportion of glycerol and trimethylolpropane.

These polyether polyols and polyester polyols are described by way of example in Kunststoffhandbuch [Plastics Handbook] 7, Becker/Braun, Carl Hanser Verlag, 3rd edition, 1993.

Other materials that can be used as component A2) are polyether polyols and/or polyester polyols in each case having primary amino groups, these compounds being as described by way of example in EP 219035 A2 and being known as ATPE (amino-terminated polyethers).

In particular, the compounds known as Jeffamine® from Huntsman, composed of α,ω-diaminopolypropylene glycols, are suitable as polyether polyols and/or polyester polyols in each case having amino groups.

Compounds that can be used as component A3) are the catalysts known for the urethane and urea reaction, e.g. tertiary amines or tin(II) or tin(IV) salts of higher carboxylic acids. Compounds that can be used as other additives are stabilizers, such as the known polyether siloxanes, or release agents, such as zinc stearate. The known catalysts or additives are described by way of example in chapter 3.4 of Kunststoffhandbuchs J. Polyurethane [Plastics Handbook J. Polyurethanes], Carl Hanser Verlag (1993), pp. 95 to 119, and the conventional quantities of these can be used.

The “B-component” is an NCO prepolymer based on polyisocyanate component B1) and on polyol component B2), and preferably has from 8 to 32% by weight NCO content, with preference from 12 to 26% by weight, particularly preferably from 12 to 25% by weight, particularly preferably from 14 to 25% by weight, with particular preference from 14 to 20% by weight.

The polyisocyanates B1) are polyisocyanates or polyisocyanate mixtures of the diphenylmethane group optionally liquefied via chemical modification. The expression “polyisocyanate of the diphenylmethane group” is the generic expression covering all polyisocyanates that are formed during the phosgenation of aniline/formaldehyde condensates and are present as individual components in the phosgenation products. The expression “polyisocyanate mixture of the diphenylmethane group” means any desired mixture of polyisocyanates of the diphenylmethane group, i.e. by way of example the phosgenation products mentioned which arise as distillate or distillation residue during the distillative separation of mixtures of this type, and any desired blends of polyisocyanates of the diphenylmethane group.

Typical examples of suitable polyisocyanates B1) are 4,4′-diisocyanatodiphenylmethane, its mixtures with 2,2′- and in particular 2,4′-diisocyanatodiphenylmethane, mixtures of these diisocyanatodiphenylmethane isomers with their higher homologs that arise during the phosgenation of aniline/formaldehyde condensates, di- and/or polyisocyanates modified via partial carbodiimidization of the isocyanate groups of the di- and/or polyisocyanates mentioned, and any desired mixtures of polyisocyanates of this type.

Compounds in particular suitable as component B2) are the polyether polyols or polyester polyols corresponding to this definition and mixtures of polyhydroxy compounds of this type. It is possible by way of example to use corresponding polyether polyols which optionally comprise organic fillers in dispersed form. These dispersed fillers are by way of example vinyl polymers that are produced by way of example via polymerization of acrylonitrile and styrene in the polyether polyols as reaction medium (U.S. Pat. Nos. 33 83 351, 33 04 273, 35 23 093, 31 10 695, DE-B 11 52 536) or polyureas or polyhydrazides that are produced via a polyaddition reaction in the polyether polyols as reaction medium from organic diisocyanates and diamines and, respectively, hydrazine (DE-B 12 60 142, DE-A 24 23 984, 25 19 004, 25 13 815, 25 50 833, 25 50 862, 26 33 293 or 25 50 796). In principle, polyether polyols or polyester polyols of the type mentioned above under A2) are suitable as component B2), as long as they have the properties mentioned.

The average molecular weight of polyol component B2) is preferably from 1000 to 16,000, in particular from 2000 to 16,000, its average hydroxy functionality being from 2.7 to 8, preferably from 2.7 to 7.

It is preferable to produce the NCO semiprepolymers B) by reacting components B1) and B2) in quantitative proportions (NCO excess) that give NCO semiprepolymers having the above mentioned NCO content. The relevant reaction here generally takes place within the temperature range from 25 to 100° C.

The moldings of the invention are produced from polyurethaneurea elastomers by the known reaction injection molding method (“RIM process”) described by way of example in DE-A 2 622 951 (US-A 4 218 543) or DE-A 39 14 718. The quantitative proportions of components A and B here correspond to the stoichiometric ratios with NCO index from 80 to 120. The moldings of the invention are generally microcellular elastomers, i.e. are not genuine foams with a foam structure visible to the naked eye.

The quantity of the reaction mixture introduced into the mold is such that the density of the moldings is from 0.7 to 1.1 g/cm³, preferably from 0.8 to 1.1 g/cm³, particularly preferably from 0.9 to 1.1 g/cm³, and with particular preference from 0.9 to 1.0 g/cm³.

The composition of the polyurethane urea elastomer (components A and B) and the contents of ammonium carbamate salts A4) are selected in such a way that the flexural modulus of elasticity of the reinforced elastomer longitudinally with respect to the fiber direction is at least 600 MPa, preferably at least 700 MPa, particularly preferably at least 800 MPa.

The starting temperature of the reaction mixture made of components A) and B) introduced into the mold is generally from 20° C. to 80° C., preferably from 30° C. to 60° C.

The temperature of the mold is generally from 30° C. to 130° C., preferably from 50° C. to 70° C. The molds used are those of the type known per se, preferably made of aluminum or steel, or are metal-sprayed epoxy molds. The internal walls of the mold used can optionally be coated with known external mold release agents in order to improve demolding properties.

The moldings produced in the mold can generally be demolded after a mold residence time of from 5 to 180 seconds. Demolding is optionally followed by conditioning at a temperature of about 60° C. to 180° C. during a period of from 30 to 120 minutes.

The resultant, preferably sheet-like PU moldings are in particular suitable for the production of flexible automobile bumpers and of flexible bodywork elements, such as doors and tailgates, wheel surrounds, and rear and front aprons of automobiles.

The invention will be explained in more detail with reference to the examples below.

### EXAMPLES

### Starting Materials:

### Semiprepolymer 1:

52.8 parts by weight of a mixture of 80% by weight of 4,4′-diisocyanatodiphenylmethane, 10% by weight of 2,4′-diisocyanatodiphenylmethane, and 10% by weight of 3-ring MDI were reacted at 90° C. with 47.2 parts by weight of polyether polyol 1.

NCO content after 2 hours: 15.4% by weight

### Polyether Polyol 1:

Polyether polyol with OH number 48 and functionality 2.8, produced via reaction of a mixture of glycerol as trifunctional starter and propylene 1,2-glycol as difunctional starter with propylene oxide/ethylene oxide in a ratio by weight of 90:10.

### Polyether Polyol 2:

Polyether polyol with OH number 28, produced via propoxylation of sorbitol as hexafunctional starter, followed by ethoxylation in a ratio by weight of 83:17, having predominantly primary OH groups.

### Ammonium Carbamate Salt (Blowing Agent)

VP.PU 191F00 A additive from Bayer MaterialScience AG (reaction product of isopropylamine and carbon dioxide) with OH number 1483.

### DETDA:

Mixture of 80% by weight of 1-methyl-3,5-diethyl-2,4-diaminobenzene and 20% by weight of 1-methyl-3,5-diethyl-2,6-diaminobenzene.

### Jeffamine D 400:

Aliphatic Diamine from Huntsman

### DABCO 33 LV:

1,4-Diazabicyclo[2.2.2]octane (33% by Weight in Dipropylene Glycol) from Air Products

### Tegostab B 8936:

Polyether-modified polysiloxane from Evonik Industries

### PRS-H:

Trifunctional polyester polyol, condensate of polyricinoleic acid and 1,6-hexanediol with molar mass 4800 g/mol

### Carbon Fiber:

Sigrafil® C30 M150 UNS from SGL Carbon (cut length 150 μm)

### Hollow Glass Microbeads:

3MTM Glass Bubbles™ iM30K from Minnesota Mining Manufacturing (3M)

The formulations described below were processed by reaction injection molding. High-pressure metering equipment was used after intensive mixing in a positively controlled mixing head to force the A- and B-component into a heated sheet mold with mold temperature 60° C. and with dimensions 300×200×3 mm by way of a restrictor-bar gate.

The temperature of the A-component was 45° C., und the temperature of the B-component was 45° C.

The mechanical values were measured prior to conditioning and after 30 minutes of conditioning at 120° C. in a convection oven and subsequent storage for 24 hours.

The mold was treated with the mold release agent EWOmold 5408 from KVS Eckert & Woelk GmbH.

### Polyol Formulation 1:

46.7% by weight of polyether polyol 2
41.7% by weight of DETDA
5.5% by weight of Zn stearate
0.7% by weight of Jeffamine D 400
4.2% by weight of PRS-H
0.9% by weight of Tegostab B 8936
0.2% by weight of DABCO 33 LV
0.1% by weight of dimethyltin bis-2,2-dimethyloctanoate
OH number of polyol formulation 1: 292

### Inventive Example 1

2.9 parts by weight of VP.PU 191F00 A and 14.6 parts by weight of Sigrafil® C30 M150 UNS 150 mu were stirred into 97.1 parts by weight of polyol formulation 1, and, under the processing conditions conventional for RIM, this mixture was injected with 144.5 parts by weight of prepolymer 1 into a mold measuring 300×200×3 mm heated to 60° C. (index 105). The molding was demolded after 30 seconds.

### Comparative Example 2

28.8 parts by weight of 3M™ Glass Bubbles™ iM3OK and then 11.5 parts by weight of Sigrafil® C30 M150 UNS 150 mu were stirred into 100 parts by weight of polyol formulation 1 and, under the processing conditions conventional for RIM, this mixture was injected with 105 parts by weight of prepolymer 1 into a mold measuring 300×200×3 mm heated to 60° C. (index 105). The molding was demolded after 30 seconds.

Mechanical properties were determined as follows:
Envelope density in accordance with DIN 53 420
Flexural modulus of elasticity in accordance with ASTM 790
Dynstat at −25° C. in accordance with DIN 53 435-DS (low-temperature toughness)
Tensile strength in accordance with DIN 53 504

Tensile strain at break in accordance with DIN EN ISO 1798 Heat deflection temperature (HDT) in accordance with DIN EN ISO 75

Viscosity accordance with DIN EN ISO 53019 (d/dt=60 l/s): d/dt=shear rate (viscometer: MCR 501 from Anton Paar)
Flexural modulus of elasticity was in each case determined longitudinally and perpendicularly with respect to the flow direction/fiber direction.

TABLE 1
Mechanical properties prior to and after conditioning

| | | Comparative | Inventive | Comparative |
|---|---|---|---|---|
| | Inventive example | example 2 | example 1 | example 2 |
| | 1 (unconditioned) | (unconditioned) | (conditioned) | (conditioned) |
| Filler | 5.2% by wt | 10% by wt. | 5.2% by wt. | 10% by wt. |
| [% by wt.] | of C fibers | of hollow glass | of C fibers | of hollow glass |
| | | beads and 4% by | | beads and 4% |
| | | wt. of | | by wt. of |
| | | C fibers | | C fibers |
| Blowing agent | Ammonium | — | Ammonium | — |
| | carbamate salt | | carbamate salt | |
| Envelope density | 950 | 990 | 950 | 990 |
| [kg/m³] | | | | |
| Longitudinal/ | 850/620 | 880/690 | 850/615 | 870/660 |
| perpendicular | | | | |
| flexural modulus | | | | |
| of elasticity [MPa] | | | | |
| Dynstat −25° C. | 15.4 | 9 | 19.2 | 13 |
| [kJ/m²] | | | | |
| Tensile strength | 23.4 | 10 | 23.3 | 10 |
| [MPa] | | | | |
| Tensile strain at | 128 | 90 | 120 | 70 |
| break [%] | | | | |
| HDT | 109 | 96 | 147 | 135 |
| [° C.] | | | | |
| Viscosity of | 230 (at 45° C.)/390 | 380 (at 50° C.)/ | 230 (at 45° C.)/ | 380 (at 50° C.)/ |
| iso/polyol [mPas] | (at 45° C.) | 780 (at 60° C.) | 390 (at 45° C.) | 780 (at 60° C.) |
| Temperature of | 45/45 | 50/60 | 45/45 | 50/60 |
| iso/polyol starting | | | | |
| material [° C.] | | | | |

Inventive example 1 shows that use of the ammonium carbamate salt VP.P1.1 191F00 A as blowing agent in combination with 5.2% by weight of carbon fiber, based on the elastomer, achieved a flexural modulus of elasticity of 850 MPa longitudinally with respect to the fiber direction and 620 MPa perpendicularly with respect to the fiber direction, while the envelope density of the molding was 950 kg/m³. If, as in comparative example 2, hollow glass beads were used for density reduction in conjunction with 4% by weight of carbon fibers, only slightly higher flexural moduli of elasticity were achieved, while the density of the moldings was about 10% higher (990 kg/m³). The mechanical values for the unconditioned sample in inventive example 1 were always markedly above those of comparative example 2. Impact resistance at −25° C. (Dynstat) in inventive example 1 was almost twice as high as in comparative example 2. Tensile strength, 23.4 MPa, was likewise markedly higher than in comparative example 2 (10 MPa). Inventive example 1 provided a very marked advantage over comparative example 2 in tensile strain at break, a very important mechanical property for polyurethane urea elastomers. Tensile strain at break, 128%, was about 30% higher than in comparative example 2. The heat deflection temperature of the unconditioned molding, 109° C., was also markedly above the I-1DT value of comparative example 2, 96° C.

Very high flexural moduli of elasticity, 850 MPa longitudinally with respect to the fiber direction and 615 MPa perpendicularly with respect to the fiber direction, were also achieved by the conditioned test samples. These values were only slightly below those of comparative example 2, while the density of the molding was markedly lower. Impact resistance at −25° C. (Dynstat) in inventive example 1, 19.2 kJ/m², was markedly above that of comparative example 2, 13 Id/m². Tensile strength, 23.3 MPa, was likewise markedly higher than in comparative example 2 (10 MPa). The marked advantage in tensile strain at break of inventive example 1 was therefore also present in the conditioned samples. The tensile strain at break value, 120%, was more than 40% higher than in comparative example 2 (tensile strain at break 70%). The heat deflection temperature of the conditioned molding, 147° C., was also markedly above the HDT value of comparative example 2, 135° C.

A particularly important factor in the processing of polyurethane urea elastomers by means of RIM is the viscosity of the starting materials at a given temperature. Low viscosity promotes good mixing of the components in the mixing head, High viscosities can therefore lead to significant mixing problems which have an adverse effect on the finished component. A low temperature of the starting materials is moreover desirable for economic reasons. In inventive example 1 the viscosity of the polyol, 230 mPas, was markedly below that of comparative example 2 (780 mPas for the polyol), and indeed at markedly lower starting material temperatures. The temperatures of both starting materials in inventive example 1, in each case 45° C., were lower than in comparative example 2 by (isocyanate) and indeed 15° C. (polyol).

The process of the invention provided a polyurethane urea elastomer which, in comparison with an elastomer produced according to the prior art, has about 10% lower density and markedly better mechanical and thermomechanical properties, for example low-temperature toughness, tensile strength, heat deflection temperature, and tensile strain at break, while flexural modulus of elasticity is comparable. External bodywork parts made of the elastomer of the invention therefore have excellent suitability for weight saving in automobile construction.

1.-5. (canceled)

6. A foamed molding comprising polyurethane urea elastomer and provided with reinforcing material and having from 70 to 95 mol % urea content and from 5 to 30 mol % urethane content, based in each case on mol % of an NCO equivalent, obtained by reaction of a reaction mixture comprising a component A comprising
A1) aromatic diamines which at least in a respective ortho-position with respect to the amino groups have an alkyl substituent,
A2) at least one aliphatic component composed of at least one polyether polyol and/or polyester polyol in each case having hydroxy and/or primary amino groups with number-average molecular weight from 500 to 18,000 and functionality from 3 to 8, and
A3) optionally catalysts and/or optionally additives,
and a component B, a prepolymer containing isocyanate groups and obtained by reaction of a reaction mixture comprising
B1) a polyisocyanate component from the group consisting of polyisocyanates and polyisocyanate mixtures of the diphenylmethane group and of liquefied polyisocyanates of the diphenylmethane group, and
B2) at least one polyol component with number-average molecular weight from 500 to 18,000 and functionality from 2.7 to 8, selected from the group consisting of polyether polyols which optionally comprise organic fillers and polyester polyols which optionally comprise organic fillers,
wherein
component A further comprises an ammonium carbamate salt (A4) and component A or component B or both component further comprise carbon fibers (C) with an average fiber length from 60 to 200 μm.

7. The molding as claimed in claim 6, wherein the average fibers lengths of the carbon fibers (C) are from 90 to 200 μm.

8. The molding as claimed in claim 6, wherein the density of the molding is from 0.7 to 1.1 g/cm³.

9. The molding as claimed in claim 6, wherein the flexural modulus of elasticity of the molding longitudinally with respect to the fiber direction is at least 600 MPa.

10. An article comprising the moldings as claimed in claim 6, wherein the article is an external bodywork part, a bodywork element, a flexible automobile bumper, a wheel surround, a doors, a tailgate, a front apron, or a rear apron.
